(19) United States
(12) Patent Application Publication
(10) Pub. No.: US 2018/0206524 A1
(43) Pub. Date: Jul. 26, 2018

(54) Extruder for Feed- and Foodstuffs

(71) Applicant: Source Technology ApS, Kolding (DK)

(72) Inventor: Thomas Kniep Jørgensen, Kolding (DK)

(21) Appl. No.: 15/745,497

(22) PCT Filed: Jul. 8, 2016
(86) PCT No.: PCT/DK2016/050245

§ 371 Date: Jan. 17, 2018

(30) Foreign Application Priority Data
Jul. 17, 2015 (DK) PA 2015 70476

(51) Int. Cl. A23J 3/26; A23P 30/20; A23J 3/04; A23J 3/14; A23J 3/22

(52) U.S. Cl. CPC A23J 3/26; A23P 30/20; A23J 3/227; A23J 3/14; A23J 3/04

(57) ABSTRACT

An extruder for making meat analogue products, where the extruder comprises a product outlet (22), and a longitudinal barrel (8) comprising an inner surface (14) and an outer surface, and where the extruder further comprises heating means for heating at least a part of said inner surface, where said barrel (8) interconnects with said product inlet (5) and outlet (22), where the extruder further comprises a rotor (16) arranged coaxially inside said barrel (8), where said rotor (16) comprises drive means (19) for rotating said rotor (16) in relation to the barrel (8).

### FIELD OF THE INVENTION

The present invention relates to an extruder for making meat analogue products, where the extruder comprises a product inlet and a product outlet, and a longitudinal barrel comprising an inner surface and an outer surface, and where the extruder further comprises heating means for heating at least a part of said inner surface, where said barrel interconnects with said product inlet and outlet and defines an interior space, where the extruder further comprises a rotor arranged coaxially inside the interior space of said barrel, where said rotor has a first end and a second end, a length, a radial thickness and an outer surface and an inner surface, where said rotor further comprises drive means for rotating said rotor in relation to the barrel.

### BACKGROUND OF THE INVENTION

Before the development of the present invention, it was known to use shear extruders for producing foodstuffs such as meat analogue products. A typically way of producing such meat analogue products is to supply an emulsion, a ground mix, a blend or a product from a storage into a mixing apparatus and further into an extruder.

In the following the term “emulsion” will be used as a general term for the above mentioned variants of the products to be processed to a meat analogue.

The process has been known for years and typically the extruder comprises a longitudinal barrel with an internal screw shaped conveyor which conveys the emulsion from an inlet to an outlet of the barrel. In order to change the texture of the emulsion, heat has to be applied to the barrel in order to heat up the emulsion during its way from inlet to outlet. Further, it has been common to design the barrel and/or the conveyor screw in a manner where a rather large internal friction or pressure is created which also applies heat to the product. Also heating of the core of the conveyor screw has been common. Heat will typically be applied in the shape of steam as well in the conveyor screw as in the barrel.

The known techniques are used in many applications all over the world with the advantage that feed- and foodstuffs can be produced form a large variety of e.g. carbohydrates and/or proteins and fats and combined into a preferred product having e.g. a structure very similar to meat or other feed- and foodstuff products.

One challenge by using the known technique is that the machinery, such as the barrel and conveyor screw, over time has a tendency to accumulate layers of product that burns onto the surface of the mentioned parts. Such deposits are built up due to the high friction and/or high temperature in such machinery as a rather large amount of heat is generated from shear in the extruder and thus the emulsion burns onto the heated surfaces. Also the heat contribution from the steam supplied to the barrel and to the conveyor has an influence on the tendency for the product to burn onto the surface of the conveyor as well as of the barrel.

During processing of the product in the known extruders the heat applied to the surface or surfaces will promote the building up of a thin membrane of product on the surface/surfaces. Such a membrane will act as an isolator and prevent heat from being transferred into the product. The membrane builds up as there is no mechanical scraping performed relatively close to the heated surfaces.

Further, a large shear force and the heat from the shear can only be obtained if the screw is very stiff and capable of transferring the large torque that will generate the heat from friction between the screw, the product and the barrel.

One of the disadvantages of this is that a time consuming cleaning has to take place on a regular basis, and that the building up of such deposits, no matter what, has at least some influence on the uniformity of the product when it leaves the extruder as the heating process is influenced by the deposits.

### OBJECT OF THE INVENTION

The object of this invention is therefore to provide an apparatus where an emulsion can be treated to take shape of e.g. a meat analogue or any other feed- or foodstuff, where the uniformity of the product is rather constant in a specific batch, and where the need for cleaning during processing of a batch of product is minimised.

Further, it is the object of the invention to provide a method for producing a feed- and/or foodstuff, where the method is performed using an apparatus as mentioned above.

Even further it is the object of the invention to provide a protein rich product such as a meat analogue, where the product is produced from a homogenous emulsion, where the product after passing through the apparatus is firm and has a layered structure.

### DESCRIPTION OF THE INVENTION

As mentioned in the introductory part above, the invention concerns an extruder for making meat analogue products, where the extruder comprises a product inlet and a product outlet, and a longitudinal barrel comprising an inner surface and an outer surface, and where the extruder further comprises heating means for heating at least a part of said inner surface, where said barrel interconnects with said product inlet and outlet and defines an interior space, where the extruder further comprises a rotor arranged coaxially inside the interior space of said barrel, where said rotor has a first end and a second end, a length, a radial thickness and an outer surface and an inner surface, and further comprises drive means for rotating said rotor in relation to the barrel.

When talking about a meat analogue in this context the term has to be understood as a general term for a protein rich product made from meat and/or vegetables and/or other products comprising protein and/or a product comprising carbohydrates. Such products may e.g. be soybeans, other types of beans, eggs or peas, sugars, starch and cellulose.

Further, said heating means may be understood strictly as means for applying heat to the product produced in the extruder, but it could also be understood as means for regulating the temperature of the product either to a higher or lower temperature. Said means may thus be construed as heat applying or heat extracting means or a combination thereof.

The new and inventive part in the solution disclosed here is that said extruder further comprises a coaxial centre core, having a cylindrical cross section, and extending at least partly in the longitudinal direction of the barrel, where the centre core comprises an outer surface, where said rotor is arranged rotatably in relation to the inner surface of the barrel and in relation to the outer surface of the centre core, where the rotor comprises drive means for direct or indirect transfer of a rotational torque at both ends of said rotor.

By applying the rotational forces at both ends of the rotor it becomes possible to operate the extruder using a rather slim and thus not so rigid rotor in the space defined by the inner side of the barrel and the outer side of the center core. To be able to fulfil specifically desired criteria during production, the thickness (in radial direction) of the blades or vanes of the rotor plays a certain role. By adding rotational forces to both ends of the rotor at the same time—either directly or indirectly—it becomes possible to obtain products having special properties, which will be described in further detail below.

The centre core is thus an individual part that does not form part of the rotor, but has the same purpose as the barrel, namely to create and define an interior space where the product can be processed. The barrel limits the outer boundary of the processing area in the extruder and the centre core, which will be arranged coaxially in the barrel, creates a ring shaped volume inside the barrel where the product is processed.

The barrel and/or the centre core may be cylindrical along the full length, but one or both of them may also be tapered, or they may have sections that are tapered and/or cylindrical or even other shapes.

It is thus possible to have for example, but not limiting:
a cylindrical barrel and a tapered centre core, where the smaller diameter of the centre core is near the product inlet,
a cylindrical barrel and a tapered centre core, where the smaller diameter of the centre core is near the product outlet,
a tapered barrel and a cylindrical centre core, where the smaller diameter of the barrel is near the product inlet,
a tapered barrel and a cylindrical centre core, where the smaller diameter of the centre core is near the product outlet,
a tapered barrel and a tapered centre core, where both of the smaller diameters are near the same end of the extruder,
a tapered barrel and a tapered centre core, where the smaller diameters are arranged in opposite ends of the extruder.

In this context, the expression “rotatably” should be understood as a relative motion/rotation between the mentioned items. The centre core may be stationary and also the barrel may be stationary and the rotor may be rotated, but the centre core as well as the barrel can also be rotatable in a relative manner, where the rotor, the centre core and the barrel are rotated in the same direction or in opposite directions with the same or with a different RPM (revolutions per minute).

Further the rotor may be tapered according to e.g. a tapered barrel and/or a tapered centre core in order to be operated in the ring shaped volume created between these parts.

The rotor may comprise vanes extending in the longitudinal direction of the extruder, where the thickness of the vanes is increasing towards the outlet end of the extruder, which may be a design option as the viscosity in the product becomes lower and lower towards the outlet and thus a larger stiffness may be appreciated in the vanes.

In an embodiment of an extruder according to the invention both of the coaxial inner surface of the barrel and the outer surface of the centre core is arranged with a uniform distance to the surfaces of the rotor, where the mentioned distance is between 0 and 3 millimetres, preferably between 0.2 and 1.5 millimetres, and where the distance between the inner surface of the barrel and the outer surface of the centre core is between 2 and 12 millimetres, and preferably between 5 and 7 millimetres, where the extruder further comprises an axial outlet.

By using suitable tolerances between the coaxial inner surface of the barrel and the outer surface of the centre core an effective process is achieved as the rather narrow tolerance of between 0 and 3 millimetres will allow for a perfect scraping of the inner surface of the barrel as well as of the outer surface of the centre core. Depending on the emulsion, also called the product as mentioned above, an even smaller tolerance between 0.2 and 1.5 millimetres may be attractive.

Further the distance between the inner surface of the barrel and the outer surface of the centre core may have a value between 2 and 12 millimetres, and preferably between 5 and 7 millimetres, which will allow the emulsion/product to build up a layered structure having a texture very much similar to regular meat. This is achieved due to the relative thin ring shaped volume between the barrel and the centre core and due to the constant scraping or moving of the emulsion during its way through the extruder.

In an embodiment of an extruder according to the invention said axial outlet has a ring shaped appearance corresponding to the ring shaped cross sectional area between the barrel and the centre core. The processed product will thus escape the extruder at the peripheries of the barrel and centre core. The product may leave the extruder at an open ring shaped opening or via a cone shaped outlet port arranged at the end of the extruder. Depending on the products produced both outlet methods may be preferred. Some products are suitable for the ring shaped open outlet and other products are preferably led via a cone shaped outlet port into a pipe or tube for further processing or transport.

The barrel may be stationary and the rotor and the centre core may be rotatable by means of suitable drive means that allows for a uniform rotational direction and speed or for a non-uniform rotational direction and/or speed. The rotor and the centre core may thus be operated in a completely individual manner in order to be rotated or to be stationary in relation to the outer barrel. Rotational speed and direction of the individual items, namely the rotor and the centre core and even the barrel, may be planned and programmed and changes in the parameters may be made during operating of the equipment or prior to operating the equipment.

The product—e.g. an emulsion—may be supplied to the extruder and pressed into the product inlet by a pump of suitable type, or by a suitable feeding apparatus, and may alternatively be assisted by the rotor. If the rotor comprises some kind of helical conveyor means, such as flights, and if the rotor is rotated relatively in a forward direction, the product will—at least—be assisted through the extruder. The rotor may also comprise longitudinal vanes that will move the product in a circumferential direction inside the extruder, and have no forwarding effect on the product.

In the following the term “vane” will be used for any type of means that forwards/moves the product inside the extruder. A vane may thus be straight or helical according to the specific needs.

The rotor, barrel and centre cores may also be operated such that the product actually faces a counter movement and thus needs to be forced by an external power source e.g. a pump, through the extruder.

In an extruder according to the invention, the centre core may comprise heating means for heating at least the outer surface of said centre core.

Such heating means may be energised by using steam applied to the interior of the centre core, electrical power or other types of energising means arranged in said centre core.

The centre core as well as the barrel may be divided into sections, where one section may perform one interaction of energy with the product and where another section may perform another interaction of energy with the product. For instance one section could heat up to a first heat/energy level, a second section could heat up to a second heat/energy level, and a third section could cool down to a third heat/energy level. An extruder according to the invention may comprise that the rotor comprises scraping means constituted by at least one vane of the rotor, where the at least one vane of the rotor extends between the first and second end of the rotor and along the outer surface of the centre core and along the inner surface of the barrel.

The scraping means—here mentioned as vanes—may comprise one or more helical screw flights, one or more essentially straight vanes along the rotor, or segmented helical or straight flights or even struts extending in a radial and/or longitudinal direction, where the mentioned means all has the purpose to scrape and move the emulsion inside the extruder. The scraping means is actually the load carrying flights or vanes of the rotor and is thus an integrated part of the rotor structure and not specifically loose scraping parts or blades added to the structural and load carrying structure of the rotor by bolting or other means for fastening. The scraping prevents the product from burning onto heated surfaces and may also have influence on the texture of the product produced in the extruder.

The cross sectional shape of a single scraping means—i.e. of one of the vanes of the rotor—may be rectangular, circular, triangular or any other suitable cross sectional shape. A preferred cross sectional shape is, however, mainly rectangular or curved having the smallest size in radial direction and the wider size in the tangential/circumferential direction.

The mentioned scraping means, being either helical, straight or having any other shape, may be designed and constructed with a relatively small tolerance as mentioned above in order to bear or nearly bear against the surface of at least one of the inner surfaces of the barrel or the outer surface of the centre core. In this way, the product will be scraped or moved in relation to the mentioned surfaces.

Further, the mentioned scraping means, flights or vanes, being straight or having any other shape, may be interconnected with further scraping means running along the same rotor in order to obtain a more rigid and stiff solution. For an example, if a rotor comprises three vanes extending along the rotor these three vanes may be interconnected to each other at at least one position along the length of the rotor. A rotor will experience a rather high torque when used, and if the rotor comprises e.g. helical scraping means, the rotor will either try to expand or to narrow itself during operation depending on the direction of rotation. This can be controlled by arranging interconnecting means between the individual scraping means e.g. between helical flights on the rotor.

A further option may be to construct an extruder according to the invention with a rotor comprising a central through-going shaft, where the through-going shaft is rigidly and at least indirectly connected to the scraping means such as vanes or flights of said rotor. Such a central through-going shaft may be used for transferring a relatively large part of the rotational torque applied on the rotor. A torque will typically be applied at a driven end of the rotor and via the central through-going shaft transferred to the other end of the rotor. It is thus not the outer parts of the rotor, such as flights or vanes of the rotor, that has to carry the full rotational torque, which allows for at less stiff construction of the mentioned scraping means. The volume between the central through-going shaft and the scraping means will be more or less filled out by the central core, which as mentioned above will apply heat to the product.

The shape of the scraping means, the size of the space between the inner surface of the barrel and the outer surface of the centre core, and the diameter/shape of the barrel and of the centre core may be chosen from a variety of designs, but it is clear that the diameters, thickness, material and tolerances, and the number, height and pitch of the flights or vanes, and other design parameters may be designed for specific products, and that the skilled person will either be able to elect the proper design and dimensions, or to use a trial and error method to work his way to his choice of design.

An extruder according to the invention may have a rotor comprising drive means for rotating said rotor, where the rotor comprises two sets of drive means, a first set at or near one end of the rotor and a second set at or near a second end of the rotor.

A rotor can be driven by one set of drive means e.g. a direct drive, a chain or belt drive, but in order to transfer the needed torque it is also possible to arrange two sets of drive means as mentioned above. These drive means will typically be synchronised in a manner that allows both drives to perform more or less equal. Such a synchronisation can e.g. be done by measuring the torque, the amperes used or by any other suitable method. This will allow for a more controlled rotation of the rotor, as the drive means can be synchronised in order for the rotor to be stressed more uniform.

An extruder as mentioned above may comprise that the mentioned heating means comprises channels and cavities.

Channels and cavities can be present in the barrel and in the centre core in a manner that allows heat to be transferred to the surfaces facing the product inside the extruder. The channels and/or cavities can be used for heated water which is not vaporised, for steam or heated oil, alternatively for electric wires or other types of heating elements whichever type of heating source is preferred.

An extruder according to the invention may comprise a rotor having a first end part and a second end part and at least one vane extending between said first and second end parts, where at least one of said end parts is releasably connected to the at least one vane, and further comprises mechanical engagement means for connecting said at least one vane to said at least one end part.

Connection between one or preferably two end parts and one or more vanes may be done using bolts or other types of mechanical fasteners. Also catch means such as a catch plate for engagement and driving one or more vanes together with one or two end parts may be used. The term catch means has to be interpreted broadly as means which will allow for a transfer of rotational torque from the drive means and to the rotor itself. One or two of the end parts may be driven by suitable drive means and the purpose of the mechanical engagement means is to transfer the rotational forces from the at least one end part to the at least one vane of the rotor.

By using vanes that can easily be taken apart from the rotor a very easy assembly and disassembly is obtained, which will be highly appreciated for many reasons, but mainly because of hygienic advantages, as every part is easy to handle and clean.

Yet another advantage by this embodiment is that the at least one end part may be designed to engage with several different vane designs. A vane may be rectangular, squared, and circular or curved in its cross sectional shape. A vane may also be straight in the direction along the extruder, but it may also be helix shaped or have any other shape e.g. S-shaped or C-shaped.

By using a system having “loose” vanes it becomes possible to exchange one type of vanes to another type according to specific process parameters using the same or other rotor end parts.

The at least one vane may have cross sections as mentioned above and it is thus possible to have a vane having suitable inner and outer diameters according to the dimensions of the barrel and the centre core. Such a vane may have a cross sectional shape as a cut out of a pipe e.g. having a shape and size of ⅓ (120 degrees) or ¼ (90 degrees) of a full pipe cross section. It is clear that the sizes of one or more vanes in an extruder as described need to be chosen according to a number of parameters e.g. the process itself, the strength of the vane or vanes and so on, which will be within the capability of the skilled person.

The end parts of the rotor may comprise means for engagement with the vanes of the rotor. Further the end parts may be driven by one or two motors—drive means.

In one embodiment the rotor end part at the inlet end of the extruder is driven by an electric motor via a chain drive. The same motor may also drive an axle arranged inside the centre core, where the second end part of the rotor is connected to said axle and arranged at the outlet end of the extruder, more precisely at the end of the centre core. The motor thus applies rotational torque at both the first rotor end part and at the second rotor end part, via said axle. In this context the rotor is driven in an indirect manner.

The drive means, the centre axle, the rotor and all means connecting these parts may be arranged in a so called rotor unit. The rotor unit comprises the mentioned parts and may be arranged in order to be installed and uninstalled as a single piece in the centre of the barrel part. During cleaning or maintenance the rotor unit can simply be disconnected and uninstalled. After ended service the rotor unit can be reinstalled, e.g. in a different setup, comprising vanes having a shape and size suitable for the job to be performed.

In another embodiment the rotor may be rotated via two separate and suitable drive means—one at each end of the rotor.

In a preferred embodiment of the invention, the extruder comprises that at least the barrel is connected to a mixing housing, and further comprises means for supply of e.g. steam, water and oil into the interior space of the extruder.

The mixing housing can be arranged directly in front of the barrel or even in the inlet end of the barrel. The emulsion—the product—will be mixed here and there may be added ingredients of any kind in this part of the process.

An extruder according to the invention can be designed with at least the rotor comprising a non-stick coating on at least a part of the rotor. Such a coating can be a polytetrafluoroethylene (PTFE) coating, a ceramic coating or any other type of suitable coating that fulfils the needs for the extruding process and for a cleaning process in a specific application. The coating may be applied to especially the scraping means of the rotor.

The invention also covers that an extruder as mentioned may comprise a number of individual extruders placed next to each other in a block of extruders.

Depending on the time, the temperature, the pressure or other parameters it can be beneficial to divide the extrusion process in a manner, where one extruder operates with other process parameters compared to a preceding or succeeding extruder. The setup using more extruders in series may also be advantageous due to space requirements or other technical reasons as the individual extruders may be designed with a shorter overall length. Also the design of the rotors can have an influence on the possible length of each extruder. If for instance the rotor has a rather narrow and non-rigid design, there can be a need for a shorter extruder in order for the rotor to be able to carry the torque. A block of extruders may also comprise a number of extruders arranged in parallel, or combinations of extruders in parallel and in series. The relevant setup may be chosen according to a specific job.

A rotor as well as a centre core can be supported in one or in both ends by bearings or support structures. The centre core can be arranged to be pulled out of the barrel as well as the rotor can be uninstalled either together with the centre core or before or after uninstalling the centre core by pulling it out of the barrel. Uninstallation of a centre core and/or rotor will typically be done due to cleaning or for changing one or another part due to wear or due to other processing needs.

An extruder according to the invention may further comprise a pre-heating and mixing tank prior to the inlet and a mixing housing.

One benefit from pre-heating, e.g. combined with a stirring process, is that the emulsion (meat, protein, fat, carbohydrates etcetera) is easier to transport at e.g. 30 degrees Celsius than at 0 degrees Celsius, the emulsion/product also has a lower tendency to burn and deposit on the rotor and on the internal surfaces of the extruder when it is pre-heated.

Pre-heating also has an effect on the viscosity of the emulsion/product, at −2 degrees Celsius an emulsion of protein and fat may have a value of Cp (centipoise) equal to 350.000, whereas at +4 degrees Celsius the value of Cp (centipoise) may be reduced to e.g. 260.000, thus reducing the dynamic shear viscosity.

Further, working the stirrer may be used to press the emulsion towards the outlet of the tank. The extruder may further comprise a pre-bin prior to the pre-heating and mixing tank.

In an embodiment of an extruder according to the invention, the extruder further comprises at least one of the following features arranged after the product outlet:
a by-pass,
a counter pressure valve,
a grilling unit,
a cooling unit,
a cutting unit.

A by-pass valve or a by-pass opening gives the opportunity to by-pass some of the product until a certain temperature, texture or other process parameters are established and allows for a distinct separation of the by-passed product from the product line until the desired properties and/or quality is established.

A counter pressure valve gives the possibility to restrain the product more or less in order to have the process in the extruder happening at a certain pressure. A counter pressure valve can be constructed in many ways, but in a simple form an ordinary valve more or less open can be used.

Also a grilling unit may be present at an extruder according to the invention, where a subsequent heat is applied to the product. The heat can be applied from a heated surface or it can be applied in the shape of heat radiation from a grill element, or even from flames.

A cooling unit may also be present to cool the produced product before further process steps such as cutting or packaging or other relevant processes.

Finally, an extruder may comprise a cutting unit that cuts the product into smaller pieces of a suitable size. The size given the product at this stage may be the final size of the product, but it may also be an intermediate size where the product will be processed even more at a later stage.

The extruder may comprise an inlet and a mixing housing that comprises a screw pump, wherein a helical conveyor in the screw pump is a self-drawing screw that sucks the product into the extruder and forces the product through the extruder. Also other types of pumps can be used and arranged in a first section, namely in a mixing and feeding section, where the product inlet is arranged, where the extruder further comprises a second section, namely a processing and heating section, where the product outlet is arranged. The second section may comprise even more subsections, where the process parameters may be different between each subsection.

An extruder as described above may comprise an internal pump driven by a motor and may have a helical conveyor, which could be a screw, in the inlet and mixing housing, and it could have another helical construction within the barrel, the helical conveyor could have vanes in sections and sections with different pitches, and the barrel could be reduced in diameter at the outlet end of the extruder. In principle, all combinations of e.g. different dimensions, shapes, flight height and pitch can be adjusted according to specific needs.

The extruder mentioned and described above may be suitable for extruding several different types of products—cold or warm, moist or dry. It is however clear that various parameters have to be adjusted for specific product types in order to obtain a preferred quality and production capacity. Relevant parameters may e.g. be temperature, rotational speed and direction of the various parts, size of the annular gap between the barrel inner surface and the centre core, tolerances between the barrel, the centre core and the rotor and other parameters, which has an influence on the process of operating an extruder according to the invention.

The invention also concerns a method of operating an extruder as mentioned above, where an emulsion, e.g. for a meat analogue, is processed in the extruder as described whereby a product is created having certain specific properties.

The invention also concerns a method for making meat analogue products from an emulsion, where the method comprises operating an extruder as described above, where the emulsion is forwarded axially through the extruder in relation to the inner surface of the barrel and in relation to the outer surface of the centre core while also being moved in a tangential direction in relation to said surfaces and heated and thus transformed from an emulsion into a firm product. Using this technique will prevent the product in the extruder from burning onto and depositing on the various parts of the extruder. Until now it has been common to use a regular screw extruder, where the screw itself is heated, but from where the product is not scraped. This allows a part of the product to deposit on the shaft of the screw, which is avoided by the method according to the invention, as the rotor is rotated relative to the surface of the centre core and of the barrel.

Another embodiment of a method for making meat analogue products from an emulsion according to the invention is that the emulsion is forwarded in the extruder with an adjusted speed allowing the emulsion to build up a specific surface structure/texture at the surfaces of the product sliding against the heated inner surfaces of the barrel and of the centre core. Using this technique will create a product having a layered structure, where the outer most layers have one desired structure and the centre layer has another and different desired structure or texture.

The invention further comprises the use of an extruder for making meat analogue products, where the extruder is used for producing e.g. pizza toppings and kebab products, where the product has a firm structure and texture, where the outermost layers of the product has a first structure and texture, and where at least one centre layer has a different structure and texture. The extruder according to the invention, and the use of it, is specifically suitable for producing such layered product having different appearance in the centre layer than at the surface layers. This is very attractive as the product thus appears like meat as the structure becomes very similar to the structure of a regular meat product.

The use of an extruder for making meat analogue products according to the invention may also comprise that the meat analogue product comprises proteins mainly from meat, or that the meat analogue product comprises proteins mainly from vegetables or that the meat analogue product comprises mainly carbohydrates. The meat analogue product may as such comprise any suitable ingredients having properties, taste or the like, which is preferred by the end users. It is possible to design the foodstuff—the product produced—in any possible combination and of course to avoid proteins and fats from animals, if desired.

Further examples of alternative solutions for an extruder as mentioned above:

An extruder for processing materials, comprising:

an elongated, substantially horizontally oriented barrel having a length and presenting an inner surface;

a central core within said barrel and extending along at least a portion of the barrel length and having an outer surface, there being a material processing zone between said barrel inner surface and said core outer surface;

an elongated rotor located within said material processing zone and having a plurality of elongated, spaced apart scraping elements each presenting a unitary scraping section within said barrel with opposed, separate, scraping surfaces which are arcuate in cross-section and respectively adjacent said barrel inner surface and said core outer surface;

a mechanical drive operably coupled with said rotor for axial rotation of the rotor relative to said barrel and core so that said arcuate scraping surfaces simultaneously scrape said inner barrel surface and said core outer surface;

a material inlet oriented for delivery of material to be processed into said processing zone; and

a product outlet oriented to receive product from said processing zone.

The extruder described above may include heating means operable to heat at least one of said inner barrel surface and said outer core surface.

The extruder as mentioned above, said heating means operable to heat both of said inner barrel surface and said outer core surface.

The extruder as mentioned above, said core being coaxially located within said barrel, said zone being substantially annular.

The extruder as mentioned above, said core being stationary.

The extruder as mentioned above, said rotor having at least one helical blade.

The extruder as mentioned above, said material inlet and product outlet being located adjacent opposite ends of said barrel.

The extruder as mentioned above, said barrel having an open outlet end, said elements extending outwardly through said barrel open end, whereby said material is carried from said barrel for collection.

The extruder as mentioned above, each of said arcuate scraping surfaces having a width greater than the thickness of the associated scraping section.

### DESCRIPTION OF THE DRAWING

The invention will be described in further detail below by means of non-limiting embodiments with reference to the drawing, in which:

FIG. 1 shows an example of an extruder having further equipment installed in front of and after the extruder.

FIG. 2 shows a cross section of an extruder barrel and a centre core with a rotor.

FIG. 3 shows a centre core and a rotor.

FIG. 4 shows an example of a centre core with a rotor having helical shaped scraping means.

FIG. 5 shows an extruder with several sections along the barrel and with a dual drive system at the rotor.

FIG. 6 shows a rotor with a central through-going shaft for transferring torque.

FIG. 7 shows a layered meat analogue product.

FIG. 8 shows a rotor unit comprising a centre core with rotor and two sets of drive means.

FIG. 9 shows the same rotor unit as seen in FIG. 8, but from a different angle.

FIG. 10 shows the first end of the rotor unit of FIGS. 8 and 9.

FIG. 11 shows the second end of the rotor unit of FIGS. 8 and 9.

FIG. 12 shows cut out details in the first end of a rotor unit.

FIG. 13 shows cut out details in the second end of a rotor unit.

In the drawing, the following reference numerals have been used for the designations used in the detailed part of the description:

### LIST OF POSITION NUMBERS

1 Extruder

2 Pre-bin

3 Pre-heating/mixing tank

4 Stirrer

5 Product inlet

6 Inlet section

7 Pump

8 Barrel

9 First barrel section

10 Second barrel section

11 Third barrel section

12 Inlets in mixing housing

13 Inlets in barrel

14 Inner surface in barrel

15 Centre core

16 Rotor

17 Scraping means

18 Flights/vanes

19 Drive means

20 Energy/steam connection to the centre core

21 Sensor

22 Product outlet

23 By-pass valve

24 Grilling section

25 Cooling section

26 Cutting section

27 Direction arrow

28 Outer surface of centre core

29 Ring shaped space in the extruder

30 Scraping blade/vane/flight

31 Scraping edge

32 Stiffener between rotor blades/vanes/flights

33 Dual drive system

34 Through-going shaft

35 Meat analogue product

36 Outer layer

37 Centre layer

38 Rotor unit

39 Electric motor

40 First set of chain drive

41 Second set of chain drive

42 First rotor end part

43 Second rotor end part

44 Mounting flange

45 Catch means

46 Cut out in vane

### DETAILED DESCRIPTION OF THE INVENTION

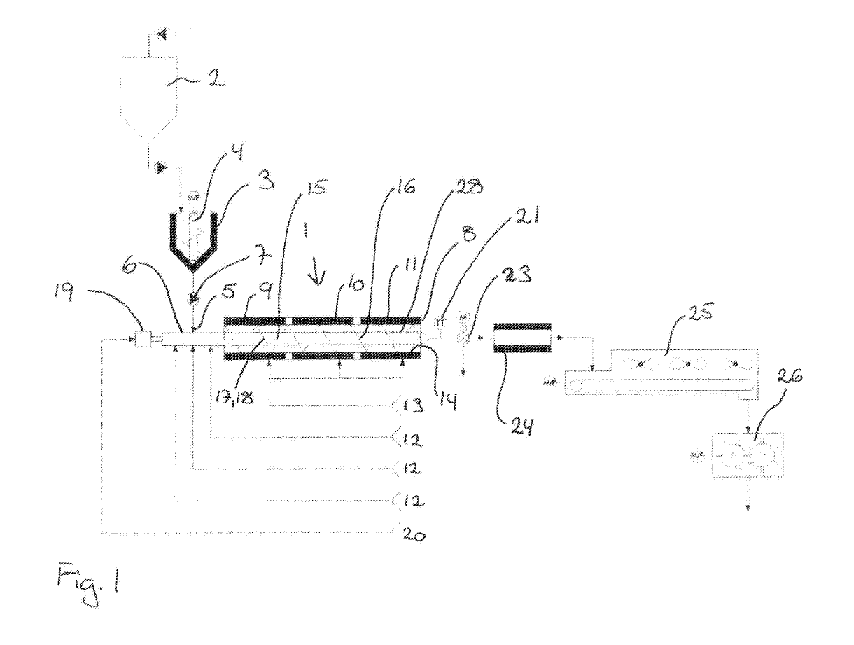

FIG. 1 shows an example of an extruder 1 having further equipment installed in front of and after the extruder 1. In front of the extruder 1, a pre-bin 2 is seen where the emulsion/product is stored and from where the product is led to a pre-heating and/or mixing tank 3. Inside the pre-heating/mixing tank 3, a stirrer 4 is seen which stirs the added product and ingredients into a homogeneous emulsion or product. The product is led further into an inlet 5 in the extruder 1 via the inlet section 6. On the inlet line a pump 7 is provided for pumping the product through the extruder 1. The inlet section 6 is connected to the barrel 8 of the extruder 1. The barrel 8 is divided into three sections 9, 10, 11 where different conditions may be present in each section 9, 10, 11.

Each section 9, 10, 11, or the barrel 8 in general, may comprise one or more sensors for detection of temperature, pressure or other process parameters that could be attractive to detect.

The inlet section 6 has inlets 12 for e.g. steam, water and oil which are led into the inlet section 6 and into the product inside the interior of the extruder 1. The barrel 8 also has inlets 13 for indirect supply of e.g. steam in order to heat up the inner surface 14 of the barrel 8.

Centrally in the barrel 8, a centre core 15 is seen depicted with a rotor 16 arranged around a stationary centre core 15, where the rotor 16 comprises scraping means 17, in the shape of a helical screw conveyor, with flights/vanes 18. The rotor 16 is rotated by means of the drive means 19 arranged at the end of the mixing housing 6. The centre core 15 is energised with e.g. steam via a connection 20.

Further down the line of the apparatus seen in FIG. 1, there is arranged a sensor 21 e.g. a temperature and/or pressure sensor at the product outlet 22 and a by-pass valve 23 that allows for a product to be bypassed until e.g. a specific temperature is measured at the sensor 21. Even further down the line, a grilling section 24 is arranged and can be used to apply a desired grill effect on the product before cooling it in a cooling section 25. The product can be led through the grilling section 24 and the cooling section 25 with or without any process taking place and into a cutting section 26, where the product can be cut into pieces of a desired size.

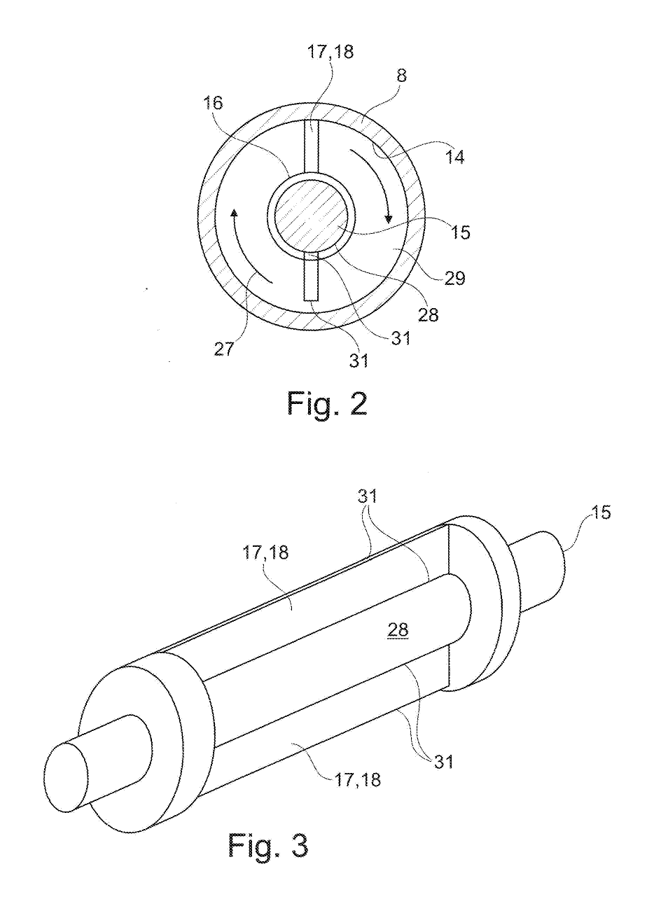

FIG. 2 shows a cross section of an extruder barrel 8 and a centre core 15 with a rotor 16. The rotor 16 rotates in the direction of the arrows 27 about a stationary centre core 15 and in relation to the stationary barrel 8. The centre core may in another embodiment of the invention be rotatable in one or both directions and with a fixed or with a variable rotational speed. The inner surface 14 of the barrel 8 and the outer surface 28 of the centre core 15 are heated and thus an emulsion of e.g. protein and fats will be processed to have a given structure/texture when forced through the ring shaped space 29 of the extruder 1. The rotor 16 is here seen as comprising two straight rectangular vanes 18, where the vanes constitute scraping means 17 having an inner and an outer scraping edge 31 for scraping the product from the inner surface 14 and the outer surface 28. It is thus the vanes 18 of the rotor 16, without any further means, that act as scraping means 17, where the scraping means 17 and scraping edges 31 actually are not in contact with the heated surface 28 or surfaces 14, 28 of the extruder 1, but operates in the vicinity of these surfaces 14, 28 according to the tolerances mentioned above.

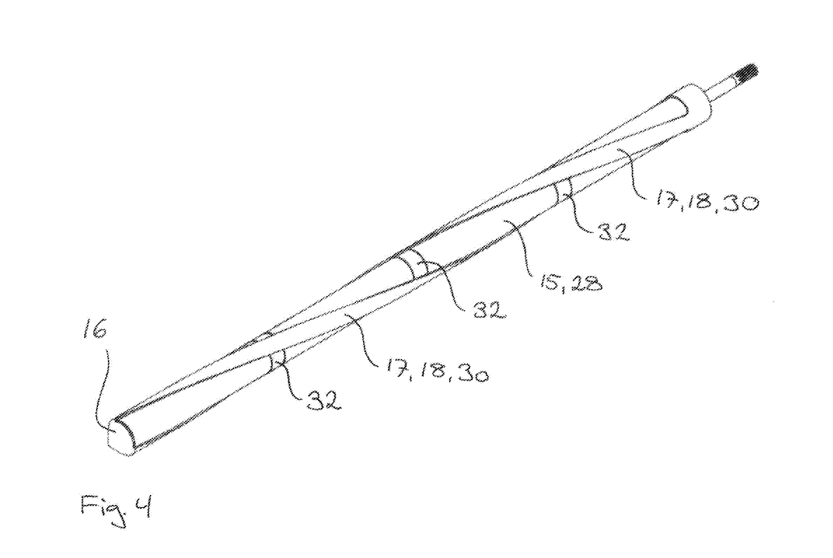

In FIG. 3, the centre core 15 and a rotor 16, as seen in FIG. 2, are seen again but here without the barrel 8. The rotor 16 is arranged to be rotatable around the centre core 15 in order to allow the vanes 18 of the rotor 16 to act as scraping means 17 in order to scrape product from the heated surfaces 14, 28—here only the outer surface 28 of the centre core 15 is seen. The end of the centre core 15 can be driven by a not shown motor, either directly or indirectly via a chain, a gear or a belt drive.

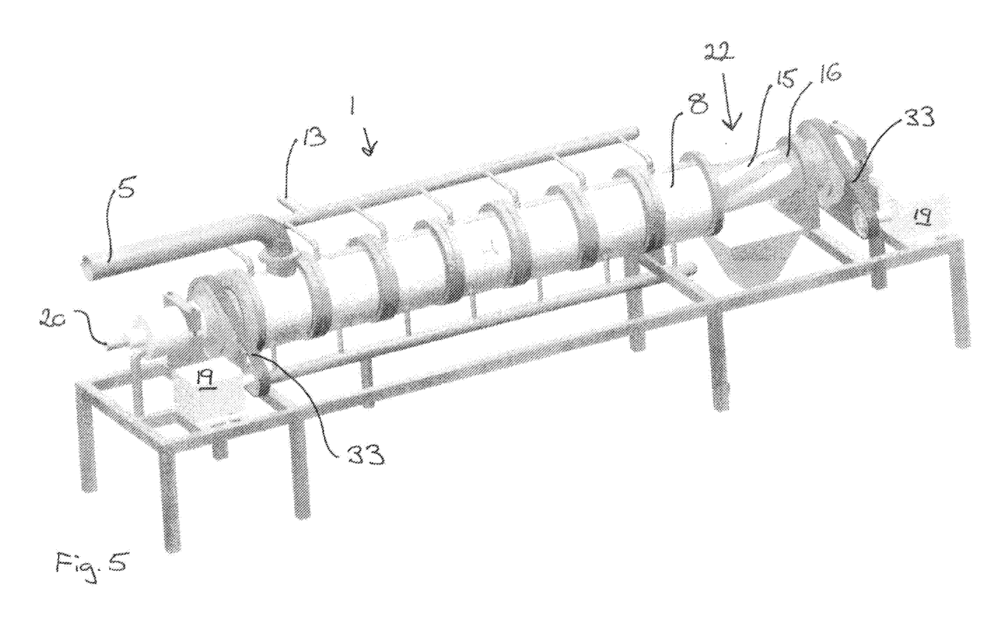

FIG. 4 shows an example of a centre core 15 with a rotor 16 having helically shaped scraping means 17. The scraping means 17 comprises several scraping blades/vanes/flights 30 and, at one end of the rotor 16, means is arranged for engagement with the drive means 19 seen in FIG. 1 and in FIG. 5. The scraping blades/vanes/flights 30 have a rather low flight height and the thickness will typically be between 2 and 12 millimetres, more preferably between 5 and 7 millimetres, and the width of the scraping blades/vanes/flights 30 will typically be between 10 to 60 millimetres. The thickness and the width can however be designed with other dimensions than mentioned.

In this figure, it can also be seen that the individual scraping blades/vanes/flights 30 are interconnected with stiffeners 32 between the individual blades/vanes/flights of the rotor 16 that allow a higher torque to be applied without overloading and deforming the rotor 16. Here three sets of stiffeners 32 are arranged along the rotor 16.

FIG. 5 shows an extruder 1 with a barrel 8 consisting of several barrel sections 9, 10, 11 along the length of the barrel 8 and with a dual drive system 33 at the ends of the rotor 16. The dual drive means are synchronised and operated via the drive means 19.

Connections 13 for steam, heated water or oil, or any other source of energy is connected to the barrel 8 and also to the centre core 15 via the connection 20. The barrel 8 has a product inlet 5 and a product outlet 22.

The stationary or rotatable centre core 15 and the barrel 8 have dimensions that create a rather narrow ring shaped space along the extruder 1, in which the rotor 16 is arranged with helical shaped scraping means 17 having a number of scraping blades/vanes/flights 30. A rotor 16 like the one seen in FIG. 5 can be used to partly urge the product from the product inlet 5 to the product outlet 22, but the rotor 16 can also be rotated in a counter acting direction, and thus used to create a counter pressure that in some applications can be useful. It is of course necessary with another energy source for forcing the product through the extruder 1—at least if the rotor 16 is rotating in a counter direction or if the rotor 16 has straight scraping blades/vanes/flights 30. In this figure the product outlet 22 is seen as an annular shaped opening between the barrel 8 and the centre core 15. The product leaves the extruder 1 via this product outlet 22 and then falls into a container or onto a conveyor—not shown.

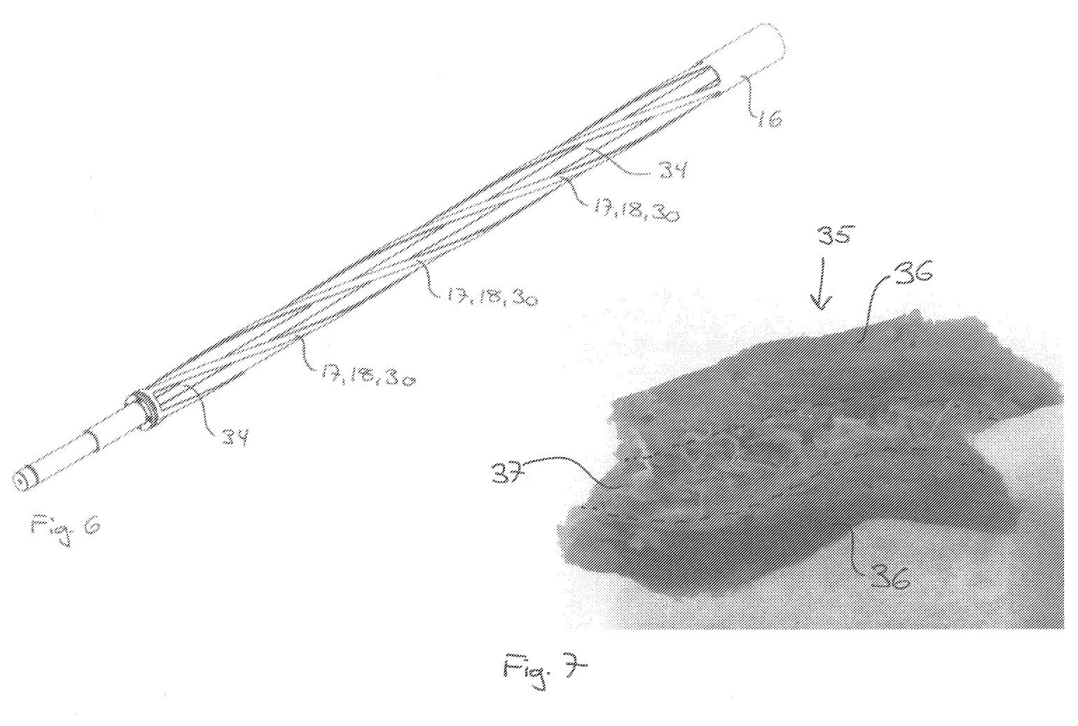

FIG. 6 shows a rotor 16 with a central through-going shaft 34 for transferring torque. The rotor 16 has helically shaped scraping means 17 with flights/vanes 18 as also seen in FIG. 4. The central through-going shaft 34 extends from one end to the other end and is connected to the scraping means 17, which comprises several scraping blades/vanes/flights 30, at the ends in order to function as a torque shaft. This allows for a more shallow construction of the scraping means 17 as they do not have to carry the full torque during the extrusion process as the central through-going shaft may take up a considerable or even the main part of the torque applied to the rotor 16.

FIG. 7 shows a meat analogue product 35 produced using an extruder 1 and a method as described above. The product 35 has a layered structure comprising two outer layers 36 and a centre layer 37. The outer layers 36 are denser and the centre layer 37 is more open and loose in the structure/texture. This layered structure is possible to create due to the technique of the extruder described above, and the main issue is that the product is moved in relation to the barrel 8 as well as in relation to the centre core 15, and that this takes place in a rather narrow ring shaped interior having suitable temperature and other suitable conditions such as e.g. moisture content. This structure and the texture of the product 35 is very meat-like and serves as an example of a protein rich product 35, made from non-meat proteins, fats and carbohydrates. Also products made from meat proteins may obtain the same structure and texture.

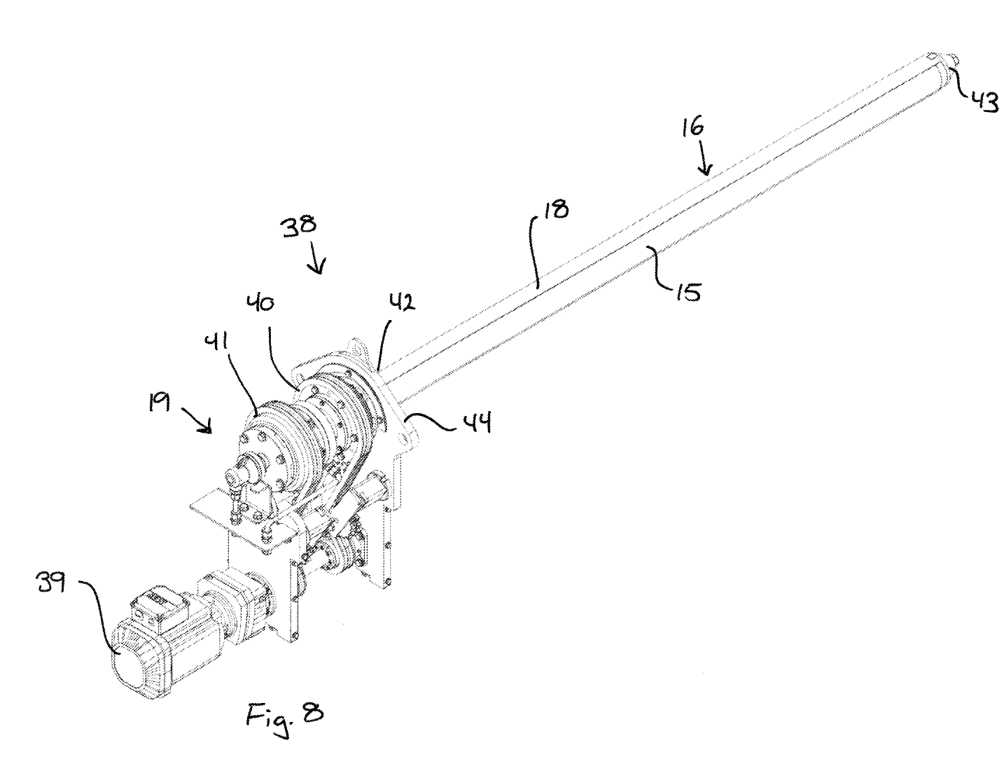

FIG. 8 shows a rotor unit 38 comprising a centre core 15 with rotor 16 and two sets of drive means 19. The drive means are driven by an electric motor 39, but could as well be driven by any other type of motor. The electric motor 39 is here connected to the drive means by a first set of chain drive 40 and a second set of chain drive 41. Here chain drives 40, 41 are used, but belt, direct drive or gear drives or other types of drives could be used as well.

The first set of chain drive 40 drives the first rotor end part 42 and the second set of chain drive 41 drives the second rotor end part 43. In the area between the electric motor 39 and the chain drives 40, 41 a mounting flange 44 is seen, which is used to fasten the rotor unit 38 to the barrel of the extruder in order to make the extruder a complete and operable unit. Along the centre core 15 one vane 18 is seen.

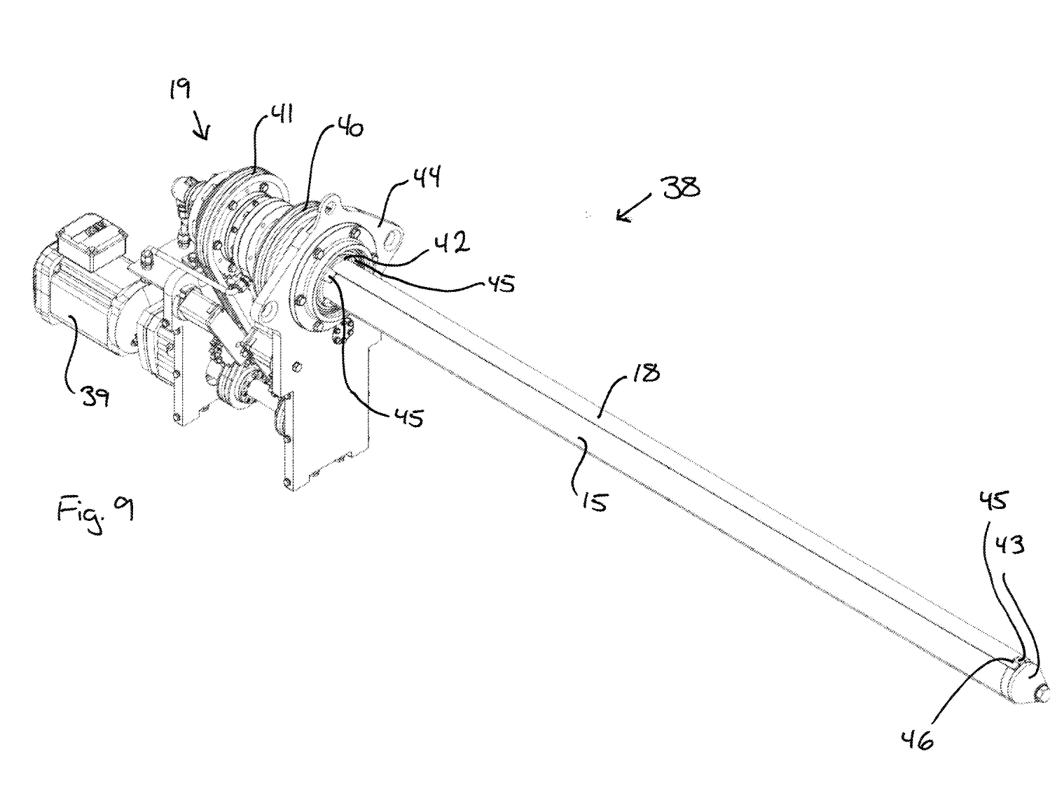

FIG. 9 shows the same rotor unit as seen in FIG. 8, but from a different angle, where the first end part 42 and the second end part 43 and the one vane 18 is seen extending between said first and second end parts 42, 43. At the first rotor end part 42, the vane 18 is releasably arranged between catch means 45 in the shape of two protrusions—one on each side of the vane 18. At the second rotor end part 43 the vane 18 is also engaged via catch means 45, but here the catch means comprises only one protrusion which engages a cut out 46 in the end of the vane 18.

FIG. 10 shows the first end of the rotor unit 38 as seen in FIGS. 8 and 9, but here in an enlarged view, where the mentioned details are seen more detailed. At the lower side of the centre core 15 a second vane 18 is seen. This second vane 18 is installed and shaped like the already mentioned vane 18. This means that both of the first and second rotor end parts 42, 43 are designed having two sets of catch means 45 and it is also possible to have rotor end parts 42, 43 comprising more than two sets of catch means 45. Said catch means 45 may be identical or different shaped in order to receive vanes 18 having a corresponding shaped end.

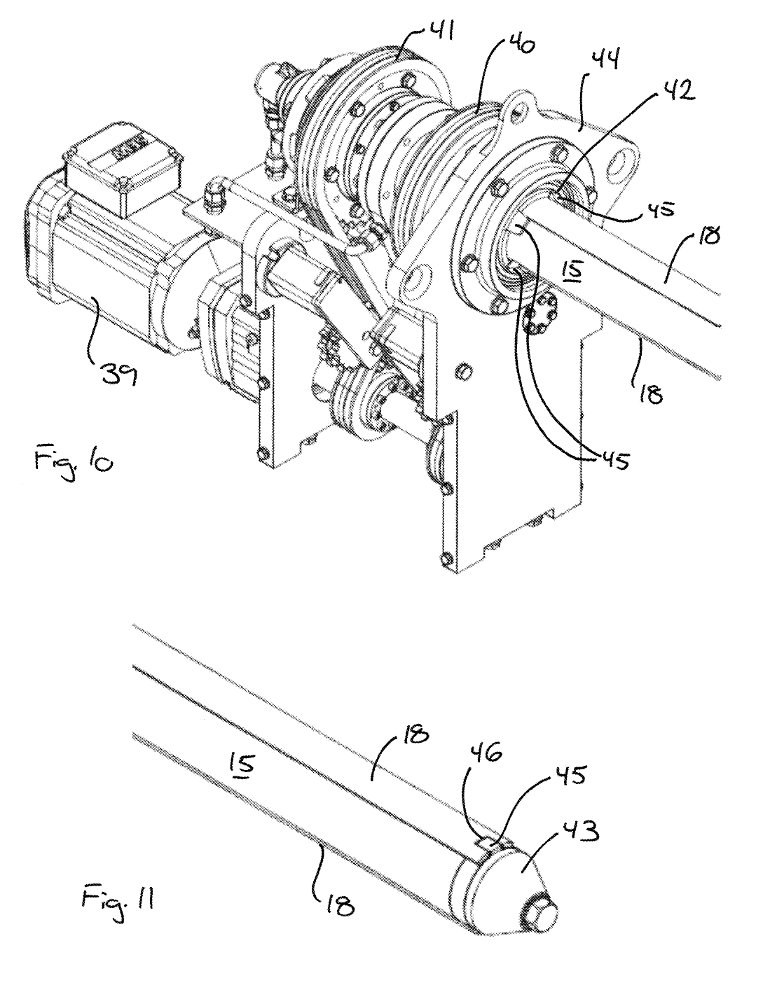

FIG. 11 shows the second end of the rotor unit 38 as seen in FIGS. 8 and 9, but here in an enlarged view, where the mentioned details are seen more detailed. At this end of the rotor unit 38 a bolt end 47 is seen which allows the second rotor end part 43 to be uninstalled, replaced by another having different catch means 45 or loosened in order to dismount the vanes 18 of the rotor 16.

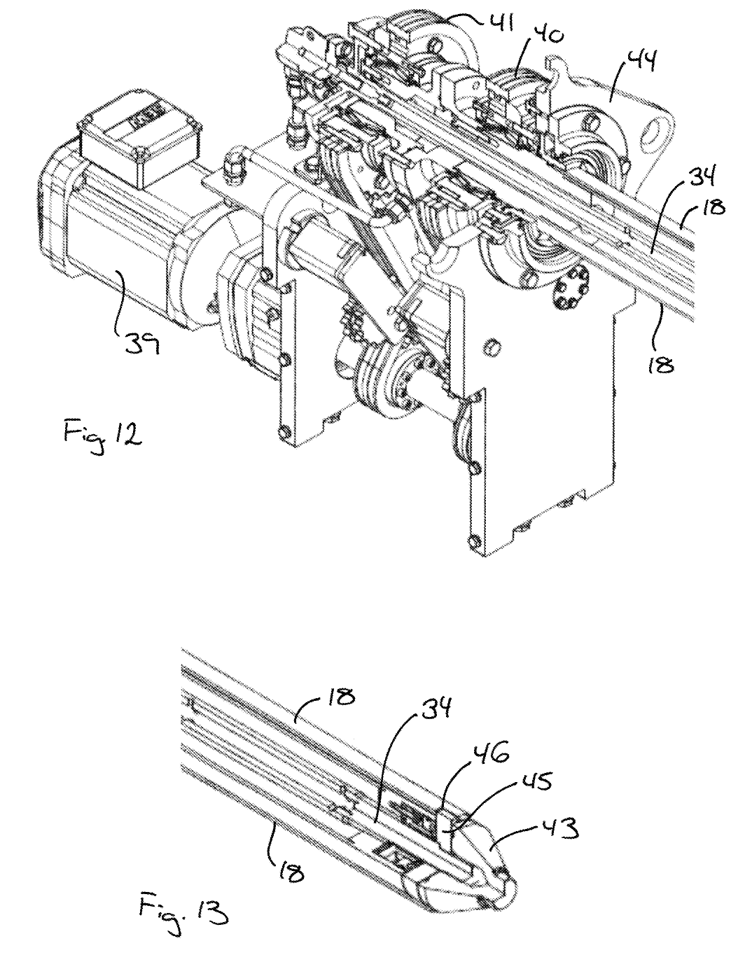

FIG. 12 shows a first end of the rotor unit 38, where there is a cut out in the drawing along the centre core 15 and rotor 16. In the centre of the centre core 15 a through-going shaft 34 is seen. Here the through-going shaft 34 serves two purposes, namely to provide steam to the interior of the centre core 15 via openings along the shaft, but also to transfer rotational torque from the drive means 19 to the second rotor end part 43, which also is seen in FIG. 13 where the second rotor end part 43 is seen.

1. Extruder for making meat analogue products, where the extruder comprises a product inlet and a product outlet, and a longitudinal barrel comprising an inner surface and an outer surface, and where the extruder further comprises heating means for heating at least a part of said inner surface, where said barrel interconnects with said product inlet and outlet and defines an interior space, where the extruder further comprises a rotor arranged coaxially inside the interior space of said barrel, where said rotor has a first end and a second end, a length, a radial thickness and an outer surface and an inner surface, where said rotor further comprises drive means for rotating said rotor in relation to the barrel wherein said extruder further comprises a coaxial centre core, having a cylindrical cross section, and extending at least partly in the longitudinal direction of the barrel, where the centre core comprises an outer surface, where said rotor is arranged rotatably in relation to the inner surface of the barrel and in relation to the outer surface of the centre core, where the rotor comprises drive means for direct or indirect transfer of a rotational torque at both ends of said rotor.

2. Extruder according to claim 1, wherein both of the coaxial inner surface of the barrel and the outer surface of the centre core is arranged with a distance to the surfaces of the rotor, where the mentioned distance is between 0 and 3 millimetres, preferably between 0.2 and 1.5 millimetres, and where the distance between the inner surface of the barrel and the outer surface of the centre core is between 2 and 12 millimetres, and preferably between 5 and 7 millimetres, where the extruder further comprises an axial outlet.

3. Extruder according to claim 2, wherein said axial outlet has a ring shaped appearance corresponding to the ring shaped cross sectional area between the barrel and the centre core.

4. Extruder according to claim 1, wherein the centre core comprises heating means for heating at least the outer surface of said centre core.

5. Extruder according to claim 1, wherein the extruder comprises means for rotating said centre core about its longitudinal axis and in relation to said longitudinal barrel.

6. Extruder according to claim 1, wherein the rotor comprises scraping means constituted by at least one vane of the rotor, where the at least one vane of the rotor extends between the first end and the second end of the rotor and along the outer surface of the centre core and along the inner surface of the barrel.

7. Extruder according to claim 1 wherein the rotor comprises a central through-going shaft, where the through-going shaft is rigidly and at least indirectly connected to vanes of said rotor.

8. Extruder according to claim 1, wherein the rotor comprises drive means for rotating said rotor, where the rotor comprises two sets of drive means, a first set at or near one end of the rotor, and a second set at or near a second end of the rotor.

9. Extruder according to claim 1, wherein the rotor comprises a first end part and a second end part and at least one vane extending between said first and second end parts, where at least one of said end parts are releasably connected to the at least one vane, and further comprises mechanical engagement means for connecting said at least one vane to said at least one end part.

10. Extruder according to claim 1, wherein at least the barrel is connected to a mixing housing, and further comprises means for supply of e.g. steam, water and oil into the interior space of the extruder.

11. Extruder according to claim 1, wherein at least the rotor comprises a non-stick coating on at least a part of the rotor.

12. Extruder according to claim 1, wherein a number of extruders are placed next to each other in a block of extruders.

13. Extruder according to claim 1, wherein the extruder further comprises a pre-heating and mixing tank prior to the inlet and a mixing housing.

14. Extruder according to claim 1, wherein the extruder further comprises at least one of the following features arranged after the product outlet:
a by-pass,
a counter pressure valve,
a grilling unit,
a cooling unit,
a cutting unit.

15. Method for making meat analogue products from an emulsion, where the method comprises operating an extruder according to claim 1 wherein the emulsion is forwarded axially through the extruder in relation to the inner surface of the barrel and in relation to the outer surface of the centre core while also being moved in a tangential direction in relation to said surfaces and heated and thus transformed from an emulsion into a firm product.

16. Method for making meat analogue products from an emulsion according to claim 15, wherein the emulsion is forwarded in the extruder with an adjusted speed allowing the emulsion to build up a specific surface structure/texture at the surfaces of the product sliding against the heated inner surfaces of the barrel and of the centre core.

17. Use of an extruder for making meat analogue products according to claim 1, wherein the extruder is used for producing e.g. pizza toppings and kebab products, where the product has a firm structure and texture, where the outermost layers of the product has a first structure and texture, and where at least one centre layer has a different structure and texture.

18. Use of an extruder for making meat analogue products according to claim 17, wherein the meat analogue product comprises proteins mainly from meat.

19. Use of an extruder for making meat analogue products according to claim 17, wherein the meat analogue product comprises proteins mainly from vegetables.

20. Use of an extruder for making meat analogue products according to claim 17, wherein the meat analogue product comprises mainly carbohydrates.
